(19) United States
(12) Patent Application Publication
(10) Pub. No.: US 2024/0174226 A1
(43) Pub. Date: May 30, 2024

(54) TRAFFIC LANE DEVIATION SUPRRESSION DEVICE

(71) Applicant: Hino Motors, Ltd., Hino-shi (JP)

(72) Inventor: Shunsuke TSUKUDA, Hino-shi (JP)

(73) Assignee: Hino Motors, Ltd., Hino-shi (JP)

(21) Appl. No.: 18/550,142

(22) PCT Filed: Mar. 3, 2022
(86) PCT No.: PCT/JP2022/009166

§ 371 Date: Sep. 12, 2023

(30) Foreign Application Priority Data
Mar. 16, 2021 (JP) 2021-042206

(51) Int. Cl. B60W 30/12

(52) U.S. Cl. CPC B60W 30/12; B60W 2520/10; B60W 2520/14; B60W 2520/20; B60W 2552/30

(57) ABSTRACT

A lane deviation suppression device includes an operability determining unit configured to determine whether a lane deviation suppression processing for suppressing deviation of a vehicle from a traveling lane is to be performed based on a yaw angle of the vehicle with respect to the traveling lane in which the vehicle travels and a vehicle body slip angle acquiring unit configured to acquire a vehicle body slip angle of the vehicle. The operability determining unit determines whether the lane deviation suppression processing is to be performed by subtracting the vehicle body slip angle from the yaw angle.

### TECHNICAL FIELD

An aspect of the present invention relates to a lane deviation suppression device that determines whether a lane deviation suppression processing is to be performed.

### BACKGROUND ART

In the related art, a technique of performing a lane deviation suppression processing for suppressing deviation of a vehicle from a traveling lane is known (for example, see Patent Literature 1).

### CITATION LIST

### Patent Literature

[Patent Literature 1] Japanese Patent No. 4402647

### SUMMARY OF INVENTION

### Technical Problem

In the lane deviation suppression processing, whether the lane deviation suppression processing is to be performed is determined based on a yaw angle or the like of the vehicle. When it is determined that the lane deviation suppression processing is to be performed, the lane deviation suppression processing is performed.

However, in a curved traveling lane, since a vehicle may turn while skidding (slipping), the vehicle turns in a state in which the vehicle is biased slightly outward with respect to the traveling lane. That is, a difference between an actual direction of the vehicle and a traveling direction of the vehicle occurs. This difference is significant in a long-wheelbase vehicle such as a truck. As a result, when the vehicle turns in a curved traveling lane, there is a problem in that determination accuracy of whether the lane deviation suppression processing is to be performed decreases. Particularly, since determination of whether the lane deviation suppression processing is to be performed on an outer lane marking in the turning direction is performed earlier, the number of times the lane deviation suppression processing is performed increases more than necessary in comparison with a case in which the vehicle travels in a straight traveling lane.

Therefore, an aspect of the present invention provides a lane deviation suppression device that can improve determination accuracy of whether a lane deviation suppression processing is to be performed.

### Solution to Problem

According to an aspect of the present invention, there is provided a lane deviation suppression device including: an operability determining unit configured to determine whether a lane deviation suppression processing for suppressing deviation of a vehicle from a traveling lane is to be performed based on a yaw angle of the vehicle with respect to the traveling lane in which the vehicle travels; and a vehicle body slip angle acquiring unit configured to acquire a vehicle body slip angle of the vehicle, wherein the operability determining unit determines whether the lane deviation suppression processing is to be performed by subtracting the vehicle body slip angle from the yaw angle.

In the lane deviation suppression device, since the vehicle body slip angle is subtracted from the yaw angle and whether the lane deviation suppression processing is to be performed is determined, a difference between an actual direction of the vehicle and a traveling direction of the vehicle is corrected. Accordingly, it is possible to improve determination accuracy of whether the lane deviation suppression processing is to be performed when the vehicle turns in a curved traveling lane. As a result, since earlier determination of whether the lane deviation suppression processing is to be performed for an outer lane marking in the turning direction, for example, in comparison with a case in which the vehicle travels in a straight traveling lane can be suppresses, it is possible to suppress an increase of the number of times the lane deviation suppression processing is performed more than necessary.

The operability determining unit may determine whether the lane deviation suppression processing is to be performed additionally based on a vehicle speed of the vehicle, a lateral distance from the vehicle to a lane marking of the traveling lane, and a curvature of the traveling lane. With this lane deviation suppression device, it is possible to more appropriately determine whether the lane deviation suppression processing is to be performed by determining whether the lane deviation suppression processing is to be performed additionally based on the vehicle speed of the vehicle, the lateral distance from the vehicle to the lane marking of the traveling lane, and the curvature of the traveling lane.

The vehicle body slip angle acquiring unit may acquire the vehicle body slip angle by multiplying a distance from a center of gravity of the vehicle to a rear wheel of the vehicle by a radius of curvature of the traveling lane. With this lane deviation suppression device, it is possible to easily acquire the vehicle body slip angle by acquiring the vehicle body slip angle by multiplying the distance from the center of gravity of the vehicle to the rear wheel of the vehicle by the radius of curvature of the traveling lane.

The lane deviation suppression device may further include a lane deviation suppression processing executing unit configured to perform the lane deviation suppression processing when the operability determining unit determines that the lane deviation suppression processing is to be performed. With this lane deviation suppression device, it is possible to suppress deviation of the vehicle from the traveling lane by performing the lane deviation suppression processing when the operability determining unit determines that the lane deviation suppression processing is to be performed.

### Advantageous Effects of Invention

According to the aspect of the present invention, it is possible to improve determination accuracy of whether a lane deviation suppression processing is to be performed.

### BRIEF DESCRIPTION OF DRAWINGS

FIG. 1 is a block diagram illustrating a configuration of a lane deviation suppression device according to an embodiment.

FIG. 2 is a diagram schematically illustrating a state in which a vehicle is traveling in a straight traveling lane.

FIG. 3 is a diagram schematically illustrating a state in which a vehicle is traveling in a curved traveling lane.

FIG. 4 is a diagram schematically illustrating a vehicle body slip angle.

FIG. 5 is a diagram schematically illustrating a longitudinal distance and a curve lateral distance.

FIG. 6 is a flowchart illustrating a flow of processing operations which are performed by the lane deviation suppression device.

### DESCRIPTION OF EMBODIMENTS

Hereinafter, an embodiment of an aspect of the present invention will be described in detail with reference to the accompanying drawings. In the following description, the same or corresponding elements will be referred to by the same reference signs and repeated description thereof will be omitted.

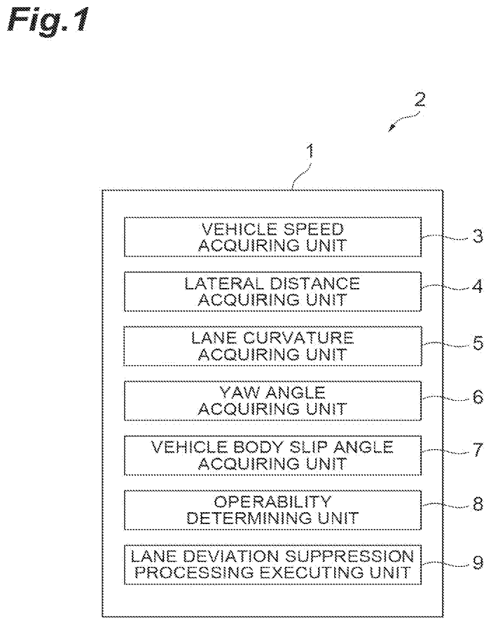

FIG. 1 is a block diagram illustrating a configuration of a lane deviation suppression device according to an embodiment. As illustrated in FIG. 1, the lane deviation suppression device 1 according to this embodiment is a device that is mounted in a vehicle 2 and determines whether a lane deviation suppression processing for suppressing deviation of the vehicle 2 from a traveling lane is to be performed. The lane deviation suppression device 1 may be a device that performs the lane deviation suppression processing.

The lane deviation suppression device 1 is constituted, for example, by a control unit mounted in the vehicle 2. The control unit is an electronic control unit (ECU) including a CPU, a ROM, and a RAM. The control unit performs various types of control by loading a program stored in the ROM to the RAM and causing the CPU to execute the program. The control unit may be constituted by a single electronic control unit or may be constituted by a plurality of electronic control units.

The lane deviation suppression device 1 includes a vehicle speed acquiring unit 3, a lateral distance acquiring unit 4, a lane curvature acquiring unit 5, a yaw angle acquiring unit 6, a vehicle body slip angle acquiring unit 7, an operability determining unit 8, and a lane deviation suppression processing executing unit 9. The vehicle speed acquiring unit 3, the lateral distance acquiring unit 4, the lane curvature acquiring unit 5, the yaw angle acquiring unit 6, the vehicle body slip angle acquiring unit 7, the operability determining unit 8, and the lane deviation suppression processing executing unit 9 may be constituted by the same electronic control unit or may be constituted by different electronic control units.

As illustrated in FIGS. 1 to 3, the vehicle speed acquiring unit 3 acquires a vehicle speed V of the vehicle 2. The vehicle speed V of the vehicle 2 can be calculated, for example, from results of detection from wheel speed sensors for detecting wheel rotation speeds.

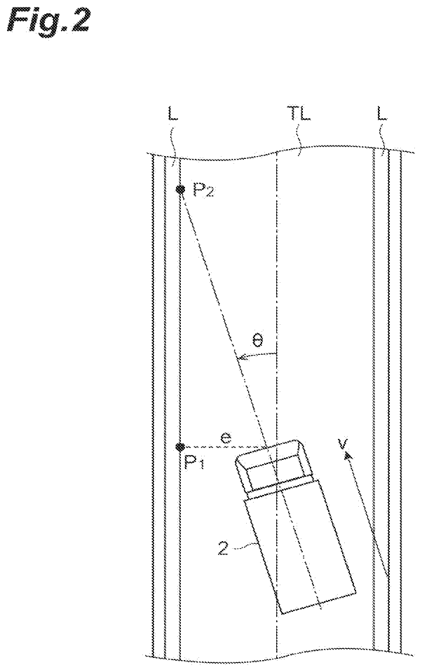

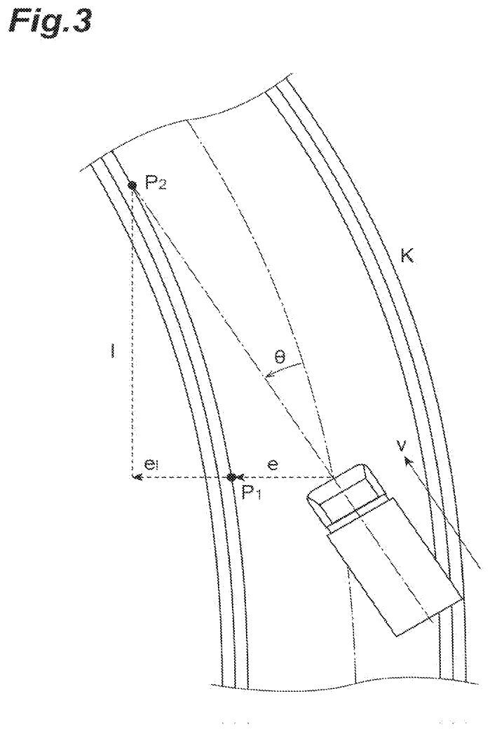

The lateral distance acquiring unit 4 acquires a lateral distance e from the vehicle 2 to a right or left lane marking L or L for defining a traveling lane TI, in which the vehicle 2 is traveling. The lateral distance e is a distance in a lane width direction of the traveling lane TL. In FIG. 3, a direction of the lateral distance e has deviated from the lane width direction of the traveling lane TL, but the lateral distance e is actually the distance in the lane width direction of the traveling lane TL as described above. The lateral distance acquired by the lateral distance acquiring unit 4 includes a lateral distance e to the lane marking L located on the left side of the vehicle 2 and a lateral distance e to the lane marking L located on the right side of the vehicle 2, and, for example, only the lateral distance e to the lane marking L located on the left side of the vehicle 2 is illustrated in FIGS. 2 and 3. The lateral distance e can be calculated, for example, by detecting the lane markings L and L using a camera mounted in the vehicle 2 or the like and calculating the lateral distance e from the detected lane markings L and L to the vehicle 2.

The lane curvature acquiring unit 5 acquires a curvature K of a curve of the traveling lane TL in which the vehicle 2 is traveling. When the radius of curvature of the traveling lane TL is defined as R, the curvature K of the traveling lane TL is expressed by K=1/R. The curvature K can be calculated, for example, by detecting the lane markings L and L using a camera mounted in the vehicle 2 or the like, calculating a virtual centerline passing through the center between the detected lane markings L and L, and calculating a curvature K or a radius of curvature R of the calculated virtual centerline. The curvature K can be calculated, for example, by acquiring a current location of the vehicle 2 acquired from a GPS or the like and comparing the acquired current location of the vehicle 2 with map information including a curvature K or a radius of curvature R of a curve.

The yaw angle acquiring unit 6 acquires a yaw angle θ of the vehicle 2 with respect to the traveling lane TL in which the vehicle 2 travels. The yaw angle θ can be calculated, for example, by detecting lane markings L and L using a camera mounted in the vehicle 2 or the like, calculating a virtual centerline passing through the center between the detected lane markings L and L, and calculating a tilt of the vehicle 2 with respect to the calculated virtual centerline.

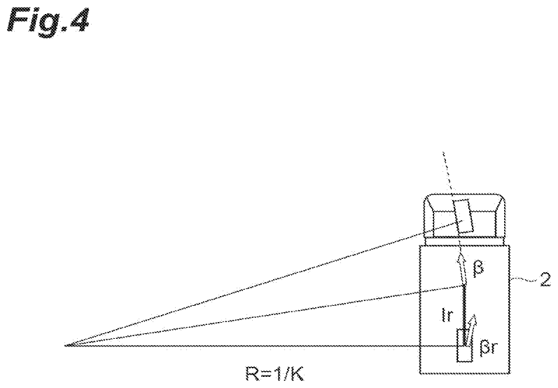

As illustrated in FIGS. 1 and 4, the vehicle body slip angle acquiring unit 7 acquires a vehicle body slip angle β of the vehicle 2. The vehicle body slip angle β is a difference between a direction of the vehicle 2 with respect to the traveling lane TL and an actual traveling direction of the vehicle 2 with respect to the traveling lane TL.

When a difference between a direction of a rear wheel tire with respect to the traveling lane TL and the actual traveling direction of the vehicle 2 with respect to the traveling lane TL is defined as βr and a distance from a center of gravity of the vehicle 2 to the rear wheel of the vehicle 2 is defined as Ir, Expression (1) is satisfied.

β+βr=Ir/R (1)

Here, since Br is small, Expression (2) is obtained by setting βr=0 in Expression (1).

β−Ir/R (2)

Accordingly, the vehicle body slip angle β can be calculated, for example, by calculating Ir/R as expressed by Expression (2).

As illustrated in FIGS. 1 to 3, the operability determining unit 8 determines whether a lane deviation suppression processing for suppressing deviation of the vehicle 2 from the traveling lane TL is to be performed based on the yaw angle θ of the vehicle 2. That is, since the vehicle 2 travels with a tilt with respect to the traveling lane TL and approaches the lane marking L, it is possible to appropriately determine whether the lane deviation suppression processing is to be performed by determining whether the lane deviation suppression processing is to be performed based on the yaw angle θ of the vehicle 2. Examples of the lane deviation suppression processing include a warning process of visually, auditorily, tactually, or the like warning a driver that the vehicle is deviating from the traveling lane TL or there is a high likelihood thereof and a steering torque applying process of applying a steering torque using a motor or the like such that vehicle 2 moves to the center of the traveling lane TL.

Here, when the vehicle 2 turns in a curved traveling lane TL, the vehicle 2 turns while generating a vehicle body slip angle β. That is, in a curved traveling lane, the vehicle 2 skids (slips) and thus turns in a state in which the vehicle is biased slightly outward with respect to the traveling lane TL. Accordingly, there occurs a difference between the actual direction of the vehicle 2 and the traveling direction of the vehicle 2. Therefore, when the vehicle 2 turns in the curved traveling lane TL, the operability determining unit 8 determines whether the lane deviation suppression processing is to be performed by subtracting the vehicle body slip angle β from the yaw angle θ.

In this embodiment, in order to more appropriately determine whether the lane deviation suppression processing is to be performed, the operability determining unit 8 determines whether the lane deviation suppression processing is to be performed additionally based on the vehicle speed V of the vehicle 2, the lateral distance e from the vehicle 2 to the lane marking L of the traveling lane TL, and the curvature K of the traveling lane TL in addition to the yaw angle θ of the vehicle 2. Determination of whether the lane deviation suppression processing is to be performed may be performed, for example, based on a predicted time t until the vehicle 2 reaches the lane marking L. That is, when the predicted time t until the vehicle 2 reaches the lane marking L is less than a predetermined threshold value, the operability determining unit 8 may determine that the lane deviation suppression processing is to be performed.

When the vehicle 2 is traveling in a straight traveling lane TL as illustrated in FIG. 2, the predicted time t until the vehicle 2 reaches a lane marking L in a yaw angle direction can be calculated, for example, as described below. The lane marking L in the yaw angle direction means a lane marking L to which the vehicle 2 is tilted with respect to the traveling lane TL out of the lane markings L and L on both sides of the vehicle 2.

A position at which a straight line extending from the vehicle 2 in the lane width direction of the traveling lane TL crosses the lane marking L in the yaw angle direction is defined as a current lateral position P₁, and a position at which a straight line extending from the vehicle 2 in the traveling direction of the vehicle 2 crosses the lane marking L is defined as a predicted arrival position P₂. The predicted arrival position P₂ is a position at which the vehicle 2 is predicted to reach the lane marking L after the predicted time t has elapsed. The vehicle speed of the vehicle 2 is defined as a vehicle speed V [m/s], a vehicle speed component of the vehicle 2 in the lane width direction of the traveling lane TL is defined as a lateral speed v_{y} [m/s] of the vehicle 2, a yaw angle of the vehicle 2 with respect to the traveling lane TL (of which a component in the counterclockwise direction is positive) is defined as a yaw angle θ[rad], and a distance from the vehicle 2 to the lane marking L in the yaw angle direction in the lane width direction of the traveling lane TL is defined as a lateral distance e [m]. The lateral distance e is a distance from the vehicle 2 to the current lateral position P₁. It is assumed that θ is sufficiently small.

In this case, since the lateral speed v_{y} [m/s] of the vehicle 2 is expressed by v_{y}=V sin θ≈Vθ, the predicted time t until the vehicle 2 reaches the lane marking L is expressed by Expression (3).

$$\begin{matrix}[ Math . 1 ] & \\ t = \frac{e}{V θ} & ( 3 )\end{matrix}$$

When the vehicle 2 is traveling in a curved traveling lane TL as illustrated in FIG. 3, the predicted time t until the vehicle 2 reaches the lane marking L can be calculated, for example, as described below.

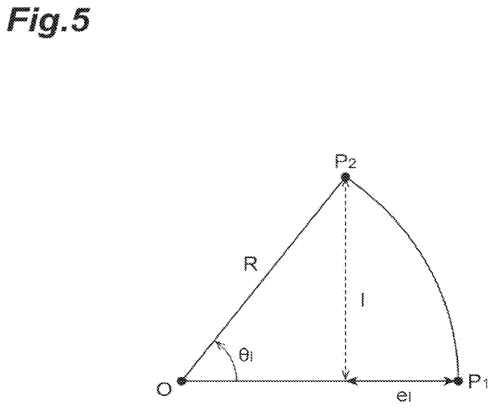

As illustrated in FIGS. 3 and 5, a position at which a straight line extending from the vehicle 2 in the lane width direction of the traveling lane TL crosses the lane marking L is defined as a current lateral position P₁, and a position at which a straight line extending from the vehicle 2 in the traveling direction of the vehicle 2 crosses the lane marking L is defined as a predicted arrival position P₂. The predicted arrival position P₂ is a position at which the vehicle 2 is predicted to reach the lane marking L after the predicted time t has elapsed. The vehicle speed of the vehicle 2 is defined as a vehicle speed V [m/s], a vehicle speed component of the vehicle 2 in the lane width direction of the traveling lane TL is defined as a lateral speed v_{y} [m/s] of the vehicle 2, a vehicle speed component of the vehicle 2 in a direction perpendicular to the lane width direction of the traveling lane TL is defined as a longitudinal speed vₓ [m/s], a distance from the current lateral position Pi in the direction perpendicular to the lane width direction of the traveling lane TL to the predicted arrival position P₂ is defined as a longitudinal distance 1 [m], a yaw angle of the vehicle 2 with respect to the traveling lane TL (of which a component in the counterclockwise direction is positive) is defined as a yaw angle θ [rad], a distance from the vehicle 2 to the lane marking L in the yaw angle direction in the lane width direction of the traveling lane TL is defined as a lateral distance e [m], a distance from the current lateral position P₁ to the predicted arrival position P₂ in the lane width direction of the traveling lane TL is defined as a curve lateral distance e₁ [m], a curvature of a curve of the traveling lane TL (of which the curvature of a left curve is positive) is defined as a curvature K [1/m], a radius of curvature of the curve of the traveling lane TL is defined as a radius of curvature R [m], and an angle formed by the current lateral position PI and the predicted arrival position P₂ with respect to the center of curvature O of the curve of the traveling lane TL is defined as an angle θ₁. It is assumed that the yaw angle θ and the angle θ₁ are sufficiently small.

In this case, since the longitudinal speed vₓ is expressed by Vₓ=V cos θ≈V, the longitudinal distance 1 is expressed by Expression (4).

### [Math. 2]

1=Vt (4)

Since the lateral speed v_{y} is expressed by v_{y}=V sin θ≈Vθ, the predicted time t until the vehicle 2 reaches the lane marking L can be expressed by Expression (5).

$$\begin{matrix}[ Math . 3 ] & \\ t = \frac{e + {e}_{1}}{V θ} & ( 5 )\end{matrix}$$

Here, as illustrated in FIG. 5, since the longitudinal distance l is expressed by l=R sin θ₁≈Rθ₁, the curve lateral distance e₁ is expressed by Expression (6).

$$\begin{matrix}[ Math . 4 ] & \\ \begin{matrix}{e}_{l} = R - R cos {θ}_{l} = R ( 1 - cos {θ}_{l} ) = R ( 1 - cos {θ}_{1} ) \cdot \frac{1 + cos {θ}_{l}}{1 + cos {θ}_{i}} \\ = \frac{R ( 1 - {cos}^{2} {θ}_{l} )}{1 + cos {θ}_{i}} = \frac{R {sin}^{2} {θ}_{l}}{1 + cos {θ}_{i}} \\ = \frac{1}{2} R {θ}_{i}^{2} = \frac{1}{2} \cdot \frac{1}{R} {l}^{2} = \frac{1}{2} {Kl}^{2}\end{matrix} & ( 6 )\end{matrix}$$

Therefore, when Expression (4) is substituted into Expression (6) as illustrated in FIG. 3, Expression (7) is obtained.

$$\begin{matrix}[ Math . 5 ] & \\ {e}_{l} = \frac{1}{2} {K ( Vt )}^{2} = \frac{1}{2} {KV}^{2} {t}^{2} & ( 7 )\end{matrix}$$

When Expression (4) is substituted into Expression (7), the predicted time t until the vehicle 2 reaches the lane marking L can be expressed by Expression (8).

$$\begin{matrix}[ Math . 6 ] & \\ \begin{matrix}t = \frac{ε + \frac{1}{2} {KV}^{2} {t}^{2}}{V θ} = \frac{- ( - V θ ) \pm \sqrt{- {( V θ )}^{2} - 4 \cdot \frac{1}{2} {KV}^{2} \cdot e}}{2 \cdot \frac{1}{2} {KV}^{2}} \\ = \frac{V θ \pm \sqrt{{V}^{2} {θ}^{2} - 2 {KeV}^{2}}}{{KV}^{2}} \\ = \frac{V θ \pm \sqrt{{θ}^{2} - 2 Ke}}{{KV}^{2}} = \frac{θ \pm \sqrt{{θ}^{2} - 2 Ke}}{KV}\end{matrix} & ( 8 )\end{matrix}$$

A condition for allowing the predicted time t to have a real solution is θ²−2Ke≥0, and the predicted time t to be calculated is small when there are two solutions. Accordingly, Expression (8) can be expressed by Expression (9).

$$\begin{matrix}[ Math . 7 ] & \\ \begin{matrix}t = \frac{θ - \sqrt{{θ}^{2} - 2 Ke}}{KV} = \frac{θ - \sqrt{{θ}^{2} - 2 Ke}}{KV} \cdot \frac{θ - \sqrt{{θ}^{2} - 2 Ke}}{θ - \sqrt{{θ}^{2} - 2 Ke}} \\ = \frac{{θ}^{2} - ( {θ}^{2} - 2 Ke )}{KV ( θ + \sqrt{{θ}^{2} - 2 Ke} )} \\ = \frac{2 Ke}{KV ( θ + \sqrt{{θ}^{2} - 2 Ke} )} = \frac{2 e}{V ( θ + \sqrt{{θ}^{2} - 2 Ke} )}\end{matrix} & ( 9 )\end{matrix}$$

Here, when K=0 (a straight line) is substituted into Expression (9), Expression (3) is obtained. Accordingly, a general expression for the predicted time t until the vehicle 2 reaches the lane marking L is Expression (10). That is, when the vehicle 2 is traveling in a straight traveling lane TL and when the vehicle 2 is traveling in a curved traveling lane TL, the predicted time t until the vehicle 2 reaches the lane marking L can be calculated by Expression (10).

$$\begin{matrix}[ Math . 8 ] & \\ t = \frac{2 e}{V ( θ + \sqrt{{θ}^{2} - 2 Ke} )} & ( 10 )\end{matrix}$$

Therefore, when the vehicle 2 is traveling in a straight traveling lane TL, the operability determining unit 8 determines whether the lane deviation suppression processing is to be performed based on the predicted time t calculated by Expression (10). That is, when the predicted time t calculated by Expression (10) is less than a predetermined threshold time, it is determined that the lane deviation suppression processing is to be performed.

On the other hand, when the vehicle 2 is traveling in a curved traveling lane TL, the operability determining unit 8 determines whether lane deviation suppression processing is to be performed based on the predicted time t calculated by subtracting the vehicle body slip angle β from the yaw angle θ in Expression (10). That is, when the predicted time t calculated by Expression (11) is less than the predetermined threshold time, it is determined that the lane deviation suppression processing is to be performed.

$$\begin{matrix}[ Math . 9 ] & \\ t = \frac{2 e}{V ( ( θ - β ) + \sqrt{{( θ - β )}^{2} - 2 Ke} )} & ( 11 )\end{matrix}$$

The lane deviation suppression processing executing unit 9 performs the lane deviation suppression processing when the operability determining unit 8 determines that the lane deviation suppression processing is to be performed.

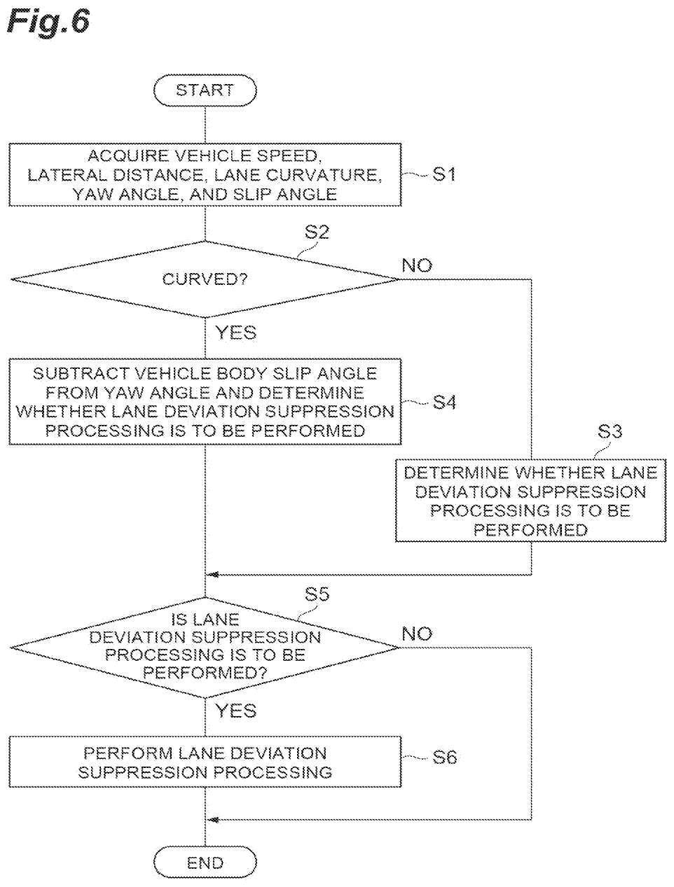

An example of a routine of processing operations which are performed by the lane deviation suppression device 1 will be described below with reference to FIG. 6.

First, the vehicle speed acquiring unit 3 acquires the vehicle speed V of the vehicle 2, the lateral distance acquiring unit 4 acquires the lateral distance e from the vehicle 2 to the lane marking L, the lane curvature acquiring unit 5 acquires the curvature K of the curve of the traveling lane TL, the yaw angle acquiring unit 6 acquires the yaw angle θ of the vehicle 2 with respect to the traveling lane TL, and the vehicle body slip angle acquiring unit 7 acquires the vehicle body slip angle β of the vehicle 2 (Step S1).

Then, the operability determining unit 8 determines whether the traveling lane TL is curved (Step S2).

When it is determined that the traveling lane TL is not curved (Step S2: NO), the operability determining unit 8 determines whether the lane deviation suppression processing is to be performed based on the yaw angle θ of the vehicle 2 (Step S3). Specifically, the operability determining unit 8 calculates the predicted time t until the vehicle 2 reaches the lane marking L using Expression (10). The operability determining unit 8 determines that the lane deviation suppression processing is to be performed when the calculated predicted time t is less than the predetermined threshold time and determines that the lane deviation suppression processing is not to be performed when the calculated predicted time t is not less than the predetermined threshold time (Step S5).

On the other hand, when it is determined that the traveling lane TL is curved (Step S2: YES), the operability determining unit 8 determines whether the lane deviation suppression processing is to be performed by subtracting the vehicle body slip angle β from the yaw angle θ. Specifically, the operability determining unit 8 calculates the predicted time t until the vehicle 2 reaches the lane marking L using Expression (11). The operability determining unit 8 determines that the lane deviation suppression processing is to be performed when the calculated predicted time t is less than the predetermined threshold time and determines that the lane deviation suppression processing is not to be performed when the calculated predicted time t is not less than the predetermined threshold time (Step S5).

When it is determined that the lane deviation suppression processing is not to be performed (Step S5: NO), the lane deviation suppression device 1 temporarily ends the routine and performs the routine again from Step S1. On the other hand, when it is determined that the lane deviation suppression processing is to be performed (Step S5: YES), the lane deviation suppression processing executing unit 9 performs the lane deviation suppression processing (Step S6). Then, the lane deviation suppression device 1 temporarily ends the routine and performs the routine again from Step S1.

As described above, in the lane deviation suppression device 1 according to this embodiment, since whether the lane deviation suppression processing is to be performed is determined by subtracting the vehicle body slip angle β from the yaw angle θ, a difference between the actual direction of the vehicle 2 and the traveling direction of the vehicle 2 is corrected. Accordingly, it is possible to improve determination accuracy of whether the lane deviation suppression processing is to be performed when the vehicle 2 turns in a curved traveling lane TL. As a result, since earlier determination of whether the lane deviation suppression processing is to be performed on the outer lane marking L in the turning direction, for example, in comparison with a case in which the vehicle 2 travels in a straight traveling lane TL can be suppresses, it is possible to suppress an increase of the number of times the lane deviation suppression processing is performed more than necessary.

By determining whether the lane deviation suppression processing is to be performed additionally based on the vehicle speed V of the vehicle 2, the lateral distance e from the vehicle 2 to the lane marking L, and the curvature K of the traveling lane TL, it is possible to more appropriately determine whether the lane deviation suppression processing is to be performed.

By acquiring the vehicle body slip angle β by multiplying the distance Ir from the center of gravity of the vehicle 2 to the rear wheel of the vehicle 2 by the radius of curvature R of the traveling lane TL, it is possible to easily acquire the vehicle body slip angle β.

By performing the lane deviation suppression processing when the operability determining unit 8 determines that the lane deviation suppression processing is to be performed, it is possible to suppress deviation of the vehicle 2 from the traveling lane TL.

While an embodiment of an aspect of the present invention has been described above, the aspect of the present invention is not limited to the embodiment and may be modified or may be applied to another embodiment without departing of the gist described in the appended claims.

For example, in the aforementioned embodiment, whether the lane deviation suppression processing is to be performed is determined based on the vehicle speed V of the vehicle 2, the lateral distance e from the vehicle 2 to the lane marking L, and the curvature K of the traveling lane TL in addition to the yaw angle θ of the vehicle 2. However, whether the lane deviation suppression processing is to be performed can be determined without using the vehicle speed V of the vehicle 2, the lateral distance e from the vehicle 2 to the lane marking L, and the curvature K of the traveling lane TL. Accordingly, whether the lane deviation suppression processing is to be performed may be determined without using the vehicle speed V of the vehicle 2, the lateral distance e from the vehicle 2 to the lane marking L, and the curvature K of the traveling lane TL. For example, it may be determined that the lane deviation suppression processing is to be performed when the yaw angle θ of the vehicle 2 is greater than a predetermined threshold angle, and it may be determined that the lane deviation suppression processing is not to be performed when the yaw angle θ of the vehicle 2 is not greater than the predetermined threshold angle. Whether the lane deviation suppression processing is to be performed may be determined based on other parameters instead of the vehicle speed V of the vehicle 2, the lateral distance e from the vehicle 2 to the lane marking L, and the curvature K of the traveling lane TL.

### REFERENCE SIGNS LIST

1 Lane deviation suppression device
2 Vehicle
3 Vehicle speed acquiring unit
4 Lateral distance acquiring unit
5 Lane curvature acquiring unit
6 Yaw angle acquiring unit
7 Vehicle body slip angle acquiring unit
8 Operability determining unit
9 Lane deviation suppression processing executing unit
e Lateral distance
e₁ Curve lateral distance
Ir Distance
K Curvature
L Lane marking
l Longitudinal distance
P₁ Lateral position
P₂ Predicated arrival position
R Radius of curvature
TL Traveling lane
V Vehicle speed
vₓ Longitudinal speed
v_{y} Lateral speed
β Vehicle body slip angle
θ Yaw angle
θ₁ Angle

1. A lane deviation suppression device comprising:
an operability determining unit configured to determine whether a lane deviation suppression processing for suppressing deviation of a vehicle from a traveling lane is to be performed based on a yaw angle of the vehicle with respect to the traveling lane in which the vehicle travels; and
a vehicle body slip angle acquiring unit configured to acquire a vehicle body slip angle of the vehicle,
wherein the operability determining unit determines whether the lane deviation suppression processing is to be performed by subtracting the vehicle body slip angle from the yaw angle.

2. The lane deviation suppression device according to claim 1, wherein the operability determining unit determines whether the lane deviation suppression processing is to be performed additionally based on a vehicle speed of the vehicle, a lateral distance from the vehicle to a lane marking of the traveling lane, and a curvature of the traveling lane.

3. The lane deviation suppression device according to claim 1, wherein the vehicle body slip angle acquiring unit acquires the vehicle body slip angle by multiplying a distance from a center of gravity of the vehicle to a rear wheel of the vehicle by a radius of curvature of the traveling lane.

4. The lane deviation suppression device according to claim 1, further comprising a lane deviation suppression processing executing unit configured to perform the lane deviation suppression processing when the operability determining unit determines that the lane deviation suppression processing is to be performed.
